(19) United States
(12) Patent Application Publication
(10) Pub. No.: US 2019/0283263 A1
(43) Pub. Date: Sep. 19, 2019

(54) Novel Shearing Device

(71) Applicant: ReExcite, LLC, Fremont, CA (US)

(72) Inventors: Shane Robert Vermette, Fremont, CA (US); Gregory Kress, Redwood City, CA (US); Scott Steber, San Francisco, CA (US)

(21) Appl. No.: 16/349,257

(22) PCT Filed: Nov. 10, 2016
(86) PCT No.: PCT/US16/61421

§ 371 Date: May 10, 2019

(51) Int. Cl. B26B 13/20; B26B 13/28

(52) U.S. Cl. CPC B26B 13/20; B26B 13/28

(57) ABSTRACT

A hand-held device consistent with the present disclosure includes a first member and a second member coupled together by a pivot point such that each member can rotate independently. The first member includes a first handle and the second member includes a second handle on a first region of each member. The area of the second handle is greater than the area of the first handle. The shearing device includes a protrusion on a second region of each member. Each protrusion is disposed at least 65 degrees from the corresponding handle of each member. The protrusion of the first member has a beveled portion above a cutting edge of the first member. During a cutting action, cross-torque force is applied upon the protrusion of the second member by the first member or a cross-torque force is applied upon the protrusion of the first member by the second member.

### PRIORITY

The present application claims the benefit of priority under 35 U.S.C. 119(e) to U.S. Non-Provisional application Ser. No. 14/589,972, entitled “A Novel Hand-Held Shearing Device” filed Jan. 5, 2015.

### FIELD

This disclosure pertains to a novel shearing device and in particular to an inverted shearing device for various cutting applications.

### BACKGROUND

Shearing devices have been around for centuries and have been used as tools to cut various materials. The most common shearing device, a pair of scissors, consists of a pair of blades linked together by a fulcrum having a pair of handles on opposing ends of the blades. Most shearing devices are designed such that the user's wrist, arm, or shoulder is not aligned during the cutting action.

Although there are shearing devices that exist which are designed to keep one's wrist aligned during a cutting action, these devices fail to allow a user to hold the device in an overhand manner. Accordingly, a need exists for a shearing device to facilitate overhand handling and provide efficient shearing generation between the blades during a cutting action. The present disclosure provides solutions for these needs.

### SUMMARY

This disclosure pertains to a hand-held shearing device and in particular to an inverted shearing device for various cutting applications. A hand-held device consistent with the present disclosure includes a first member and a second member coupled together by a pivot point such that each member can rotate independently. The first member includes a first handle and the second member includes a second handle on a first region of each member. In some implementations, the area of the second handle is greater than the area of the first handle.

The hand-held shearing device includes a protrusion on a second region of each member. Each protrusion is disposed at least 65 degrees and at most 115 degrees from the corresponding handle of each member. Furthermore, an interior angle portion disposed between the first region and the second region of one of the members can include a rounded-chamfered material guide.

### BRIEF DESCRIPTION OF THE DRAWINGS

To facilitate understanding, identical reference numerals have been used, where possible, to designate identical elements that are common to the drawings. The drawings are not necessarily to scale and the relative dimensions of various elements in the drawings are depicted schematically and not necessarily to scale. The techniques of the present disclosure may readily be understood by considering the following detailed description in conjunction with the accompanying drawings, in which:

FIG. 1 is an exploded view of a hand-held shearing device consistent with the present disclosure.

FIG. 2 is a perspective view of a hand-held shearing device consistent with the present disclosure.

FIGS. 3A-3C illustrate back, side, and bottom views of a hand-held shearing device consistent with the present disclosure.

FIGS. 4A-4C illustrate members of the hand-held shearing device while device transitions from an open position to a closed position.

FIG. 5 illustrates a perspective view of a hand-held shearing device consistent with the present disclosure in the process of cutting a shearable medium.

FIG. 6A is an exploded view of another hand-held shearing device consistent with the present disclosure.

FIG. 6B is a perspective view of the hand-held shearing device from FIG. 6A.

FIG. 7A is an exploded view of yet another hand-held shearing device consistent with the present disclosure.

FIG. 7B is a perspective view of the hand-held shearing device from FIG. 7A.

FIGS. 8A-8B are perspective view of another embodiment of a hand-held shearing device consistent with the present disclosure.

FIG. 9 is a close-up view of a chamfered portion of the shearing device's blades according to an embodiment of the present disclosure.

FIGS. 10A-10D are exemplary illustrations of the hand-held shearing device of FIG. 8 being held in a strength operating mode.

FIGS. 11A-11D are exemplary illustrations of the hand-held shearing device of FIG. 8 being held in a precision operating mode.

FIG. 12 is an exemplary illustration of a manner in which the hand-held shearing device produces cross-torque according to a right-handed embodiment of the present embodiment.

FIG. 13 is another exemplary illustration of a manner in which the hand-held shearing device produces cross-torque according to a right-handed embodiment of the present embodiment.

FIG. 14 is an illustration of a first side of another hand-held shearing device embodiment of the present invention.

FIG. 15 is an illustration of a close-up view of one of the protrusions of the hand-held shearing device of FIG. 14.

FIG. 16 is an illustration of a second side of another hand-held shearing device embodiment of the present invention.

### DETAILED DESCRIPTION

A detailed description of some embodiments is provided below along with accompanying figures. The detailed description is provided in connection with such embodiments, but is not limited to any particular example. Numerous specific details are set forth in the following description in order to provide a thorough understanding. These details are provided for the purpose of example and the described techniques may be practiced according to the claims without some or all of these specific details. For the purpose of clarity, technical material that is known in the technical fields related to some embodiments has not been described in detail to avoid unnecessarily obscuring the description.

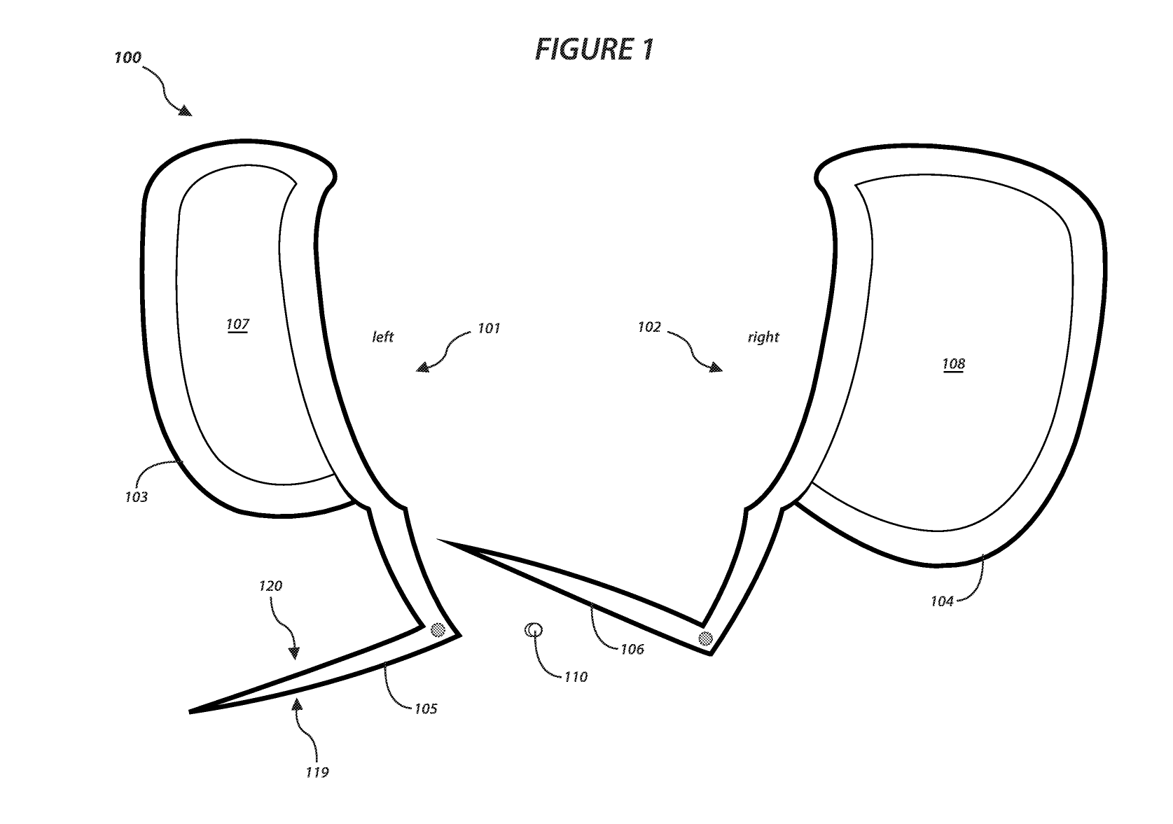

FIG. 1 is an exploded view of a hand-held shearing device 100 consistent with the present disclosure. Hand-held shearing device includes a left member 101, right member 102, and pivot member (e.g., fulcrum 110). It should be understood by one having ordinary skill in the art that a hand-held shearing device consistent with the present disclosure may be readily disassembled for such purposes of cleaning, sharpening, maintenance, etcetera. The shearing device 100 may be further designed and fashioned in such a way that it can be disassembled and reassembled without the need of additional tools.

Left member 101 and right member 102 both include a handle on a first region and a protrusion on a second region. Left member 101 includes a handle 103 and a protrusion 105. Likewise, right member 102 includes a handle 104 and a protrusion 106. Notably, handles 103, 104 are disposed above protrusions 105, 106 to facilitate an overhand grip.

An “overhand grip” may be characterized a manner in which a user grips the handles 103, 104 such that a plane through the user's wrist and hand, which may be straight and aligned, is located above, but not necessarily intersect, a plane through the protrusions 105, 106 while the user is handling the shearing device 100. Further, in response to erecting shearing device 100 in an upright position, each respective blade 105, 106 is disposed below each corresponding handle to facilitate an overhand grip of the shearing device 100. Accordingly, the inverted shearing device 100 disclosed herein facilitates an overhand grip handling of the device 100.

Contrary to conventional shearing devices, when the overhand grip is employed, the user's wrist is located above, and is aligned with, the protrusions of the shearing device 100. It should be noted that this disclosure does not preclude a user from using the shearing device 100 in an upside down position (“underhand grip”) such that when the user grips the handle, the protrusions are positioned above the wrist.

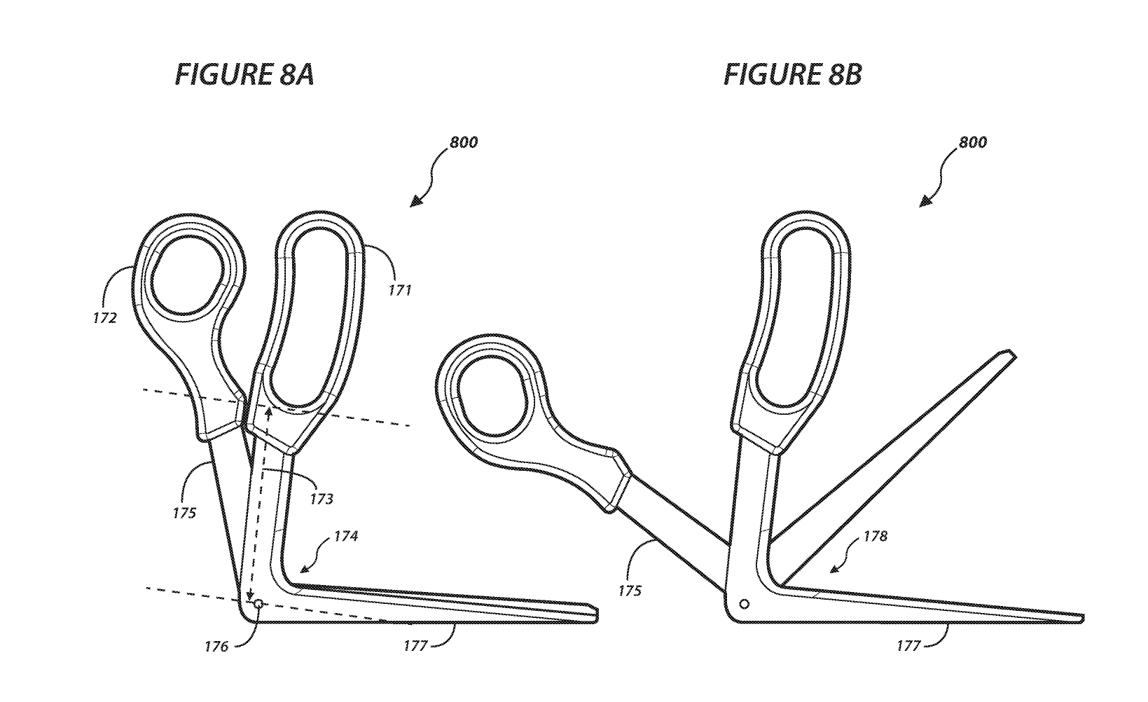

In some embodiments, handles 103, 104 have an eye-ring shape. In some embodiments, the area 108 of handle 104 exceeds the area 107 of handle 103, or vice-versa as shown in FIG. 8. Protrusions 105, 106 may be any one of a set of blades, prongs, needles, or the like. In some embodiments, protrusions 105, 106 are blades which feature a dull edge 119 and a cutting edge 120. Protrusions 105, 106 may be blunted or otherwise modified to improve safety or utility.

Fulcrum 110 may couple left member 101 and right member 102 together in a manner such that each member 101, 102 can rotate independently in a clockwise or counterclockwise direction. Fulcrum 110 may be an individual component of shearing device 100 or may be a component of left or right members 101, 102.

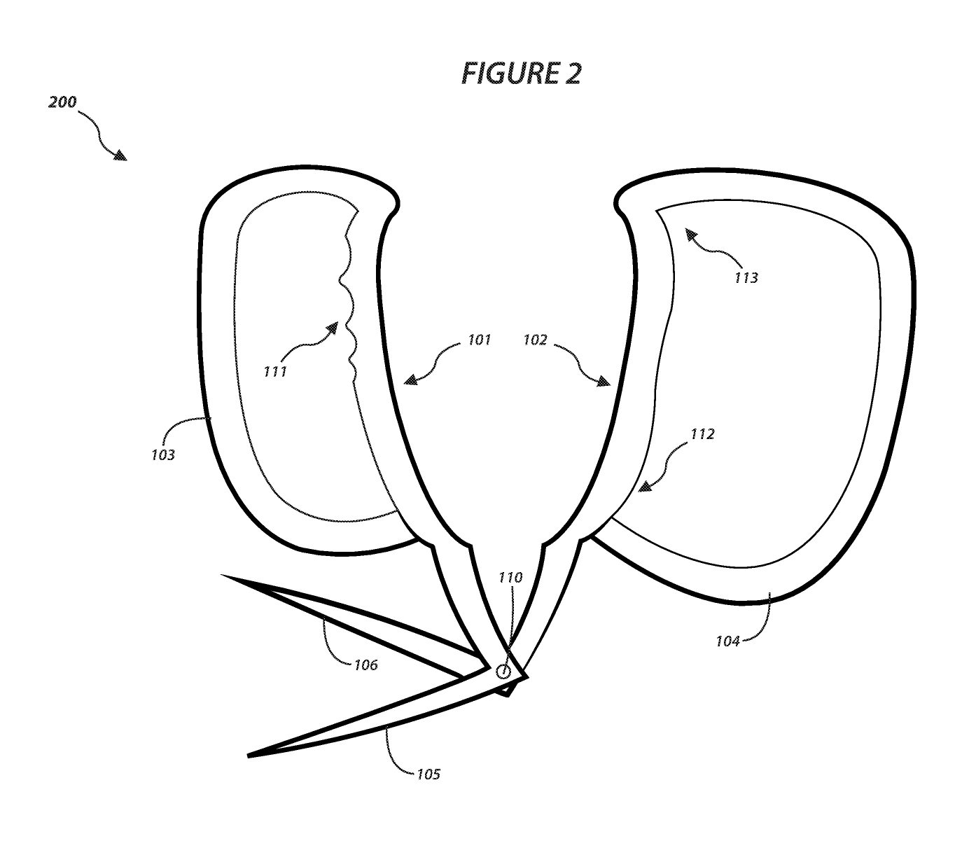

FIG. 2 is a perspective view of an assembled hand-held shearing device 200 consistent with the present disclosure. Elements of shearing device 200 may be incorporated in any of a pair of cutters, clippers, graspers, pliers, or spreaders. As such, a shearing device consistent with the present disclosure is not limited to cutting applications but may be used for various other non-shearing means. In the embodiment shown, the shearing device 200 is a novel pair of scissors or shears.

In some embodiments, handles 103, 104 of left and right members 101, 102 are disposed approximately at least 65 degrees and at most 115 degrees from blades 105, 106, respectively. However, the present disclosure is not limited thereto. As such, left and right members 101, 102 are designed to facilitate an overhand grip when the hand-held shearing device 200 is in use. Advantageously, a shearing device consistent with the present disclosure helps keep a user's wrist aligned and the user's arm and shoulder down while cutting conventional materials as well as materials which do not bend well.

Handles 103, 104 may be shaped to facilitate a sturdy grip to the shearing device 200. For example, handle 103 may have a set of dimensions such that a user's fingers (i.e., index, middle, ring, and pinky) can be fitted there through to effect a grip with handle 103. For example, an inside portion 111 of handle 103 may include finger grooves. Likewise, handle 104 may have palm heel and thumb supports 112, 113 as shown in the figure.

Accordingly, handles 103, 104 may be fashioned to allow a user to gain maximum leverage thereon to facilitate better control of the hand-held shearing device 200. During operation, a user may push the hand-held shearing device 200 with a user's palm or base of the thumb along the cutting path and may direct the shearing device's 200 cutting path with the user's fingers. As such, shearing device 200 facilitates palm, heel, base of the thumb, and finger control while allowing the user to maintain wrist alignment along the cutting path.

In some implementations, the cutting path created by shearing device 200 need not follow a straight line. For example, blades 105, 106 may be curved, jagged, or otherwise deviate from a straight line to suit various applications. Moreover, blades 105, 106 need not be symmetrical.

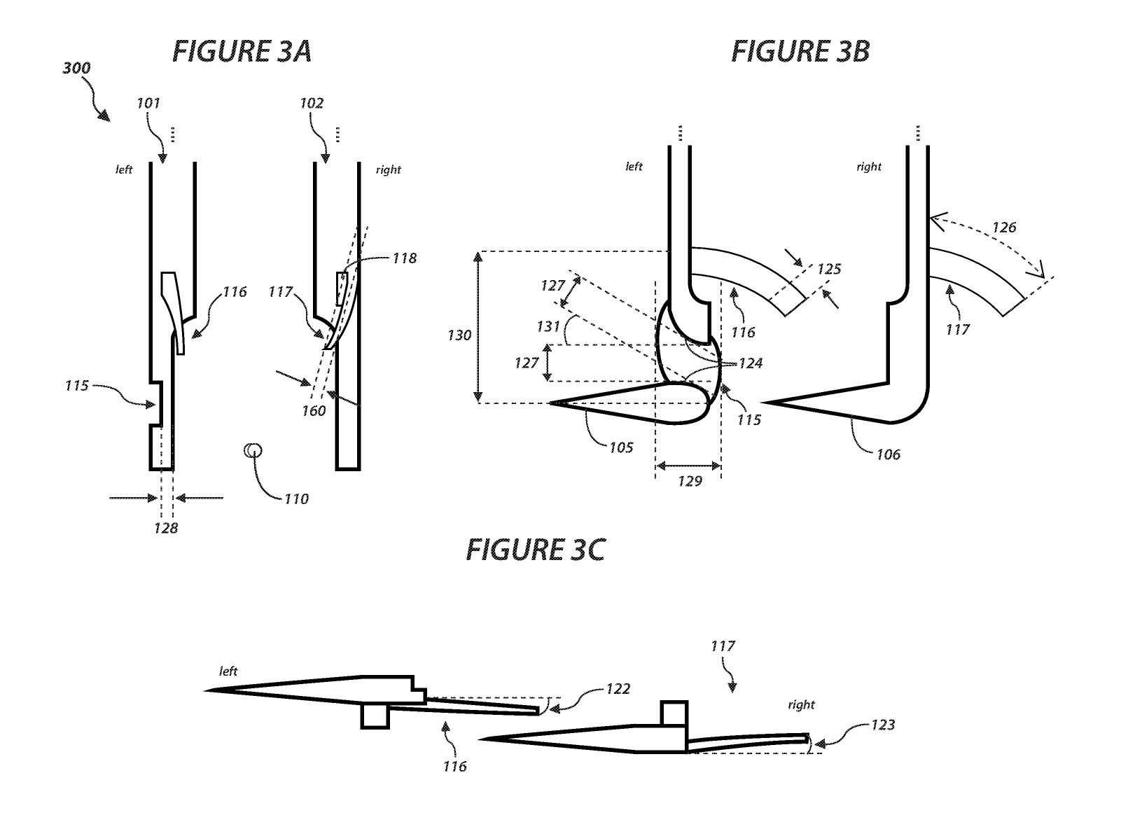

FIGS. 3A-3C illustrate back, side, and bottom views of a hand-held shearing device 300 consistent with the present disclosure. With respect to FIG. 3A, the back view of left and right members 101, 102 expose the location of fulcrum 110, material guide 115, and cross-torque extensions 116, 117. FIG. 3B exposes the contour of the material guide 115 and the cross-torque extensions 116, 117.

Referring to FIG. 3A, cross-torque extensions 116, 117, cavity 118, and fulcrum 110 interact together to create a shearing effect with blades 105, 106. Advantageously, the interaction between the cross-torque extensions 116, 117, cavity 118, and fulcrum 110 can produce a cross-torque similar to the torque created by a user's fingers with a pair of conventional scissors during a cutting action. Notably, a hand-held shearing device consistent with the present disclosure may be designed to create a cross-torque without significant manual manipulation of the left and right members 101, 102.

A portion (i.e., engage length 125) of cross-torque extension 116 traverses at least partially through cavity 118 of right member 102 when the shearing device 300 begins to close during a cutting action. In some implementations, at least half of cross-torque extension 116 traverses through cavity 118 when shearing device 300 begins to close. In other implementations, more or less of cross-torque extension 116 may traverse through cavity 118 when the hand-held shearing device 300 begins to close so long as these portions exceed the engage length 125.

In some embodiments, cross-torque extension 116 traverses through cavity 118 an engage length 125 before the cross-torque is generated. In some embodiments, the engage length 125 should be maximized such that cross-torque extension 116 traverses as far through cavity 118 before the cross-torque extensions 116, 117 create significant cross-torque. Furthermore, in some implementations, engage length 125 should be as long as possible without hindering the shearing device's 300 ability to open to a large enough angle to be useful for various shearing applications.

Furthermore, the extension length 126 (e.g., arc length) of cross-torque members 116, 117 should be maximized without hindering (e.g., intersecting) the medium that is being cut. In some embodiments, the extension length 126 of cross-torque extensions 116, 117 may be measured in angular degrees (e.g., at least 45 degrees or greater). In some embodiments, cross-torque extensions 116, 117 are arc-shaped and have the same length. Furthermore, cross-torque extensions 116, 117 may be arcs of the same circle about the fulcrum 110.

In some implementations, as the shearing device 300 closes, the blades 105, 106 push against each other at the cavity 118, the location at which cross-torque extension 116 traverses at least partially there through. In addition, as the blades 105, 106 close, they also push against each other at the point where cross-torque extensions 116, 117 touch.

In some embodiments, the body of either one or both of cross-torque extensions 116, 117 may have a lateral curvature which may aid in creating cross-torque when the shearing device transitions to a closed position. The lateral curvature of the cross-torque extensions 116, 117 may be defined by the maximum distance 160 that the extensions 116, 117 deviate from a straight line in a lateral direction. It should be noted that a lateral curvature is distinguishable from a longitudinal direction in which the cross-torque extensions' 116, 117 “arc-shape” readily exemplifies such curvature.

Referring now to FIG. 3C, cross-torque extensions 116, 117 are angled towards each other such that when shearing device 300 is engaged in a cutting action, the cross-torque extensions 116, 117 attempt to force fulcrum 110 apart thereby creating the shearing effect between the blades 105, 106.

In addition, during a cutting action, portions of the handles of each member 101, 102 may shear together. Accordingly, the portions of the handles that shear together may be modified (e.g., rounded) to prevent a sharp cutting or pinching intersection while maintaining the shearing effect.

In some embodiments, a material guide 115 is disposed on a side of left member 101 which allows a shearable medium being cut to pass freely by the member (e.g., left member 101) that extends below the medium. As shown, the portion of left member 101 which makes up the material guide 115 may be relatively thin with respect to the remaining portions of left member 101 to reduce the amount that the shearable medium bends as the medium traverses through the material guide 115 during a cutting action. In some embodiments, the thickness 128 of material guide 115 is thin enough to allow a medium to pass there through but without compromising the flexural strength of the shearing device 300. The thickness 128 of material guide 115 need not be uniform and may be thinner on its leading edge in order to reduce the chance that it binds with the medium during a cutting action.

The top and bottom portions of material guide 115 may have a rounded portion 124 to minimize the height and width of the material guide 115 needed to retain the shearing device's 300 flexural strength. Advantageously, the rounded portions 124 of material guide 115 allow a shearable medium to traverse along a straight path through material guide 115 even when left member 101 is disposed at an angle.

In some embodiments, the height 127 of material guide 115 may be minimized to limit the extent to which the flexural strength of shearing device 300 is affected by material guide 115. However, the height 127 of material guide 115 should sufficiently accommodate a shearable medium. For example, the height 127 of material guide 115 may accommodate paper, plastic, an anti-theft container, a metal mesh or sheeting, or a few sheets of cardboard.

In addition, the width 129 of material guide 115 may be minimized to aid the turning mobility of the shearing device 300 within the medium being cut while retaining the flexural strength of the device 300. In some embodiments, the width 129 of material guide 115 may be inversely proportional to the thickness 128 of material guide 115. The width 129 of material guide 115 may also depend on the strength of the material composition of the shearing device 300.

Consistent with prior art devices, hand-held shearing device 300 may be placed in an open or closed position as characterized by the position of each protrusion 105, 106 in relation to each other. In an open state, the tips of protrusions 105, 106 are displaced from each other (e.g., angular distance). The angle at which hand-held shearing device 300 is fully open during use may be referred to as the open angle 131. The open angle 131 of hand-held shearing device 300 may range from 30-75 degrees. However, the present disclosure is not limited thereto.

Furthermore, the distance (i.e., extension distance 130) between cross-torque extensions 116, 117 and the fulcrum 110 may be optimized such that the extension distance 130 may be minimized to efficiently generate cross-torque when cross-torque extensions 116, 117 are engaged. In some implementations, the extent to which extension distance 130 can be minimized is proportional to the engage length 125 and the extension length 126 of which both should be maximized in these implementations.

FIG. 3C exposes the shape and length of cross-torque extensions 116, 117 from a bottom view. In particular, this figure exposes extension angles 122, 123 of cross-torque extensions 116, 117. In some implementations, extension angles 122, 123 are functions of the aforementioned dimensions. In some embodiments, cross-torque extension 117 may be non-uniformly convex such that after cross-torque extension 116 traverses through cavity 118 past the engage length 125, additional cross-torque is generated while the hand-held shearing device transitions from an open position to a closed position. As such, various amounts of cross-torque at various points of a cutting action may be achieved by varying the extension angles 122, 123 of the cross-torque extensions 116, 117.

It should be noted that the present disclosure is not limited to the bodies of cross-torque extensions' 116, 117 lateral displacement. In some embodiments, one or both of cross-torque extensions 116, 117 may be laterally displaced so long as both extensions 116, 117 are able to generate sufficient cross-torque. For example, the extension angle 122 of cross-torque extension 116 may have a greater angle than the extension angle 123 of cross-torque extension 117. Extension angles 122, 123 may range from 0-1.5 degrees in some implementations.

In some embodiments, only one of cross-torque extensions 116, 117 has a lateral displacement (i.e., extension angle is equal to zero) whereas the other extension is laterally displaced (e.g., positive or negative extension angle). In some implementations, extension angles 122, 123 may be relatively small due to the fact that any overlap of the cross-torque extensions 116, 117 may generate some amount of cross-torque.

Moreover, cross-torque extensions 116, 117 may extend from the handles of each member 101, 102. However, in some embodiments, cross-torque extensions 116, 117 extend from other portions (or components) of the left and right member 101, 102 in a transverse direction therefrom.

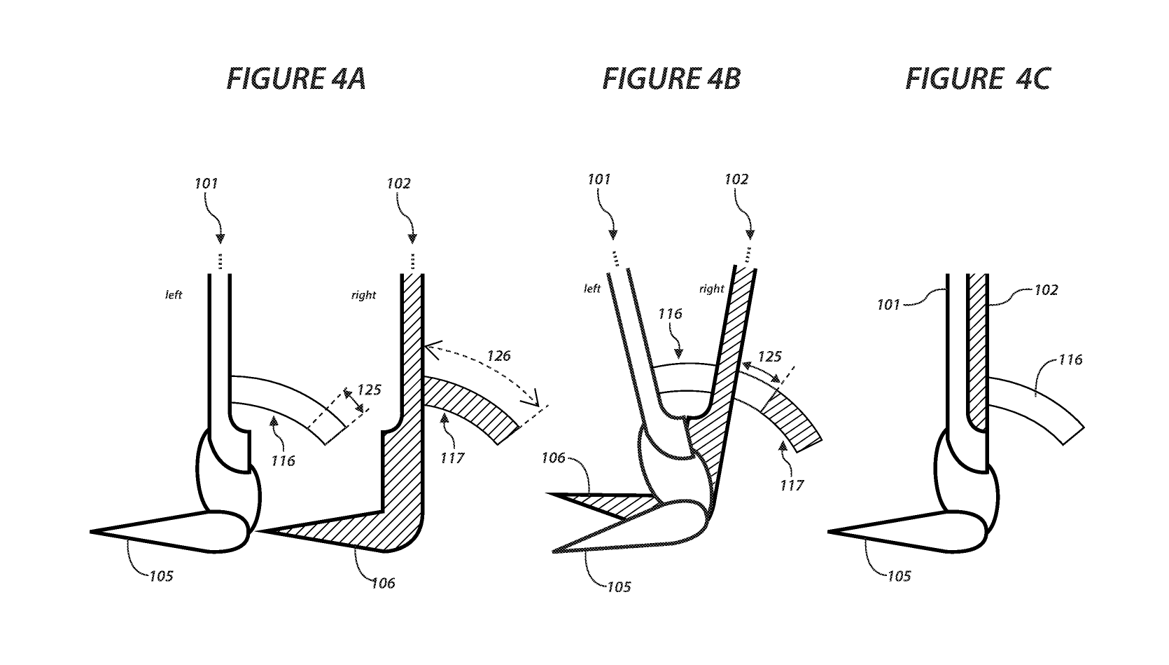

FIGS. 4A-4C illustrate members 101, 102 of hand-held shearing device while the device transitions from an open position to a closed position. It should be understood by one having ordinary skill in the art that when the hand-held shearing device is engaged in a cutting action, members 101, 102 transition from an open to a closed position.

In FIG. 4A, cross-torque extensions 116, 117 and protrusions 105, 106 of the members 101, 102 are exposed. As described in FIG. 3, the engage and extension lengths 125, 126 of the cross-torque extensions are also shown in the figure. During this transition, protrusions 105, 106 become closer aligned to effect a cutting action of a shearable medium as illustrated in FIG. 4B.

Moreover, cross-torque extension 116 traverses through a cavity (see cavity 118 in FIG. 3A) within member 102 and becomes more aligned with cross-torque extension 117 such that from a side profile, the portion of the cross-torque extension 116 that has traversed through the member's 102 cavity shadows this extension 117. In the embodiment shown, both cross-torque extensions 116, 117 have an arc-shape such that when the hand-held shearing device transitions to a closed position, the extensions are parallel and adjacent to each other along arcs of a circle about the fulcrum (not shown).

FIG. 4C illustrates a shearing device in a closed position. In the embodiment shown, when the shearing device reaches the closed position, cross-torque extension 116 completely shadows cross-torque extension 117 from a side-view perspective. In addition, both members 101, 102 are adjacent to each other which is consistent with the positions of the respective handles when the shearing device is closed.

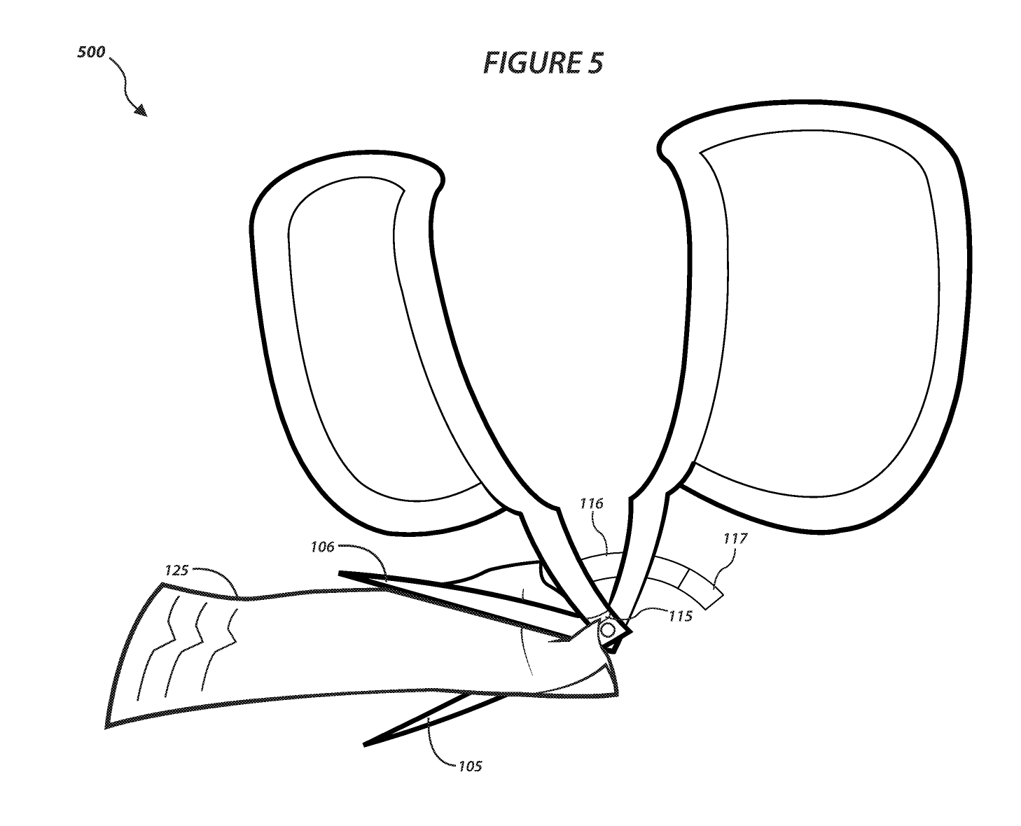

FIG. 5 illustrates a perspective view of a hand-held shearing device 500 in the process of cutting a shearable medium 125. In the figure, shearable medium 125 is paper but the present disclosure is not limited thereto. Notably, material guide 115 allows shearable medium 125 to pass freely past member 101 while being cut by the shearing device 500. It should be noted that in preferred embodiments, material guide 115 is disposed above the fulcrum 110. However, material guide 115 may be located below fulcrum 110.

Shearing device 500 may be adapted to accommodate left or right handedness or implement ergonomic features known in the art. Blades 105, 106 of hand-held shearing device 500 may be positioned further from the handles while maintaining the basic design disclosed herein to reduce the risk of an accident caused by the blades 105, 106. The position of the blades 105, 106 can be adjusted for leverage and the length of the blades 105, 106 may be increased or decreased, either symmetrically or asymmetrically, without departing from the spirit and scope of the present disclosure.

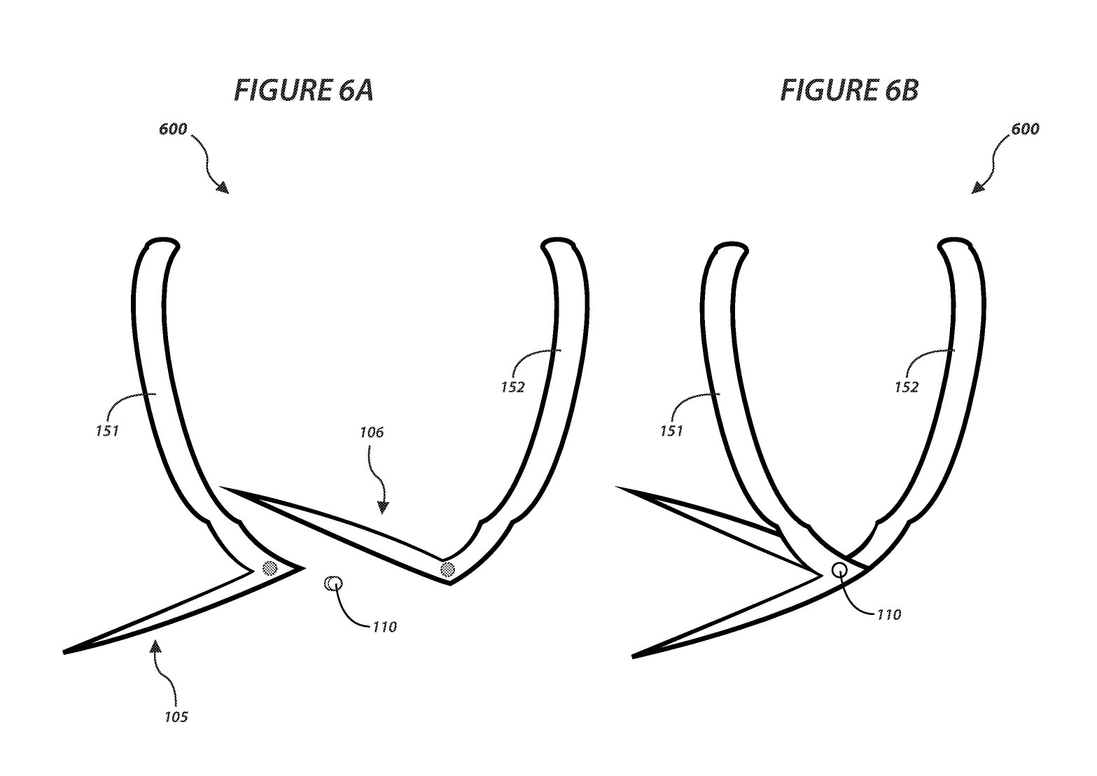

FIG. 6A is an exploded view of another hand-held shearing device 600 consistent with the present disclosure. The members 151, 152 of shearing device 600 have a substantially “L” shape such that the handle portions are approximately 90 degrees from the blade portions. When assembled, the members 151, 152 are coupled together via a fulcrum 110 which need not be a separate component nor a permanent attachment of members 151, 152.

FIG. 6B is a perspective view of the hand-held shearing device 600 from FIG. 6A. Hand-held shearing device 600 may be handled by grasping the sides of the handles with one's fingers, thumb, and/or palm heel. Shearing device 600 may include cross-torque extensions 116, 117 (along with a cavity in one of the members 151, 152) to enhance the shearing effect of the blades 105, 106.

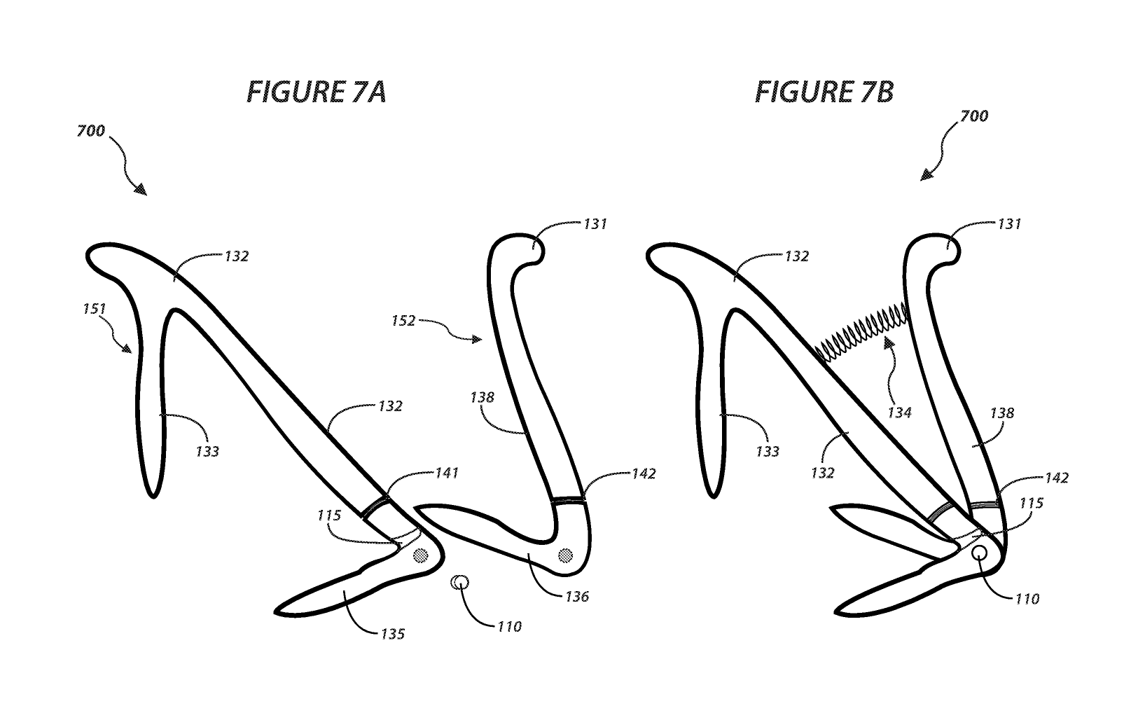

FIG. 7A is an exploded view of yet another hand-held shearing device 700 consistent with the present disclosure. As shown, hand-held shearing device 700 may comprise first and second members 151, 152 which when assembled are coupled together via fulcrum 110. The first and second members 151, 152 may each include shafts 132, 138 from which handles 131, 133 and blades 135, 136 extend therefrom on opposing ends. Notably, handle 133 has a greater length than that of handle 131. Shearing device 700 may include cross-torque extensions 116, 117 extending from the shafts 132, 138.

Advantageously, the dimensions of handle 133 accommodate the placement of a user's fingers thereon to facilitate finger control of the shearing device 700. Likewise, the dimensions of handle 131 accommodate the placement of a user's thumb thereon.

FIG. 7B is a perspective view of the shearing device 700 from FIG. 7A. In addition to the components previously described, the shearing device 700 may include a compressive resistance element such as a spring 134 disposed between first and second members 151, 152. In addition, a material guide 115 may be readily added to the shearing device 600 in a manner consistent with the present disclosure.

Although the shearing device 700 is directed to shearing and cutting applications, the shearing device 700 may be adapted to plying or prying applications by replacing the blades 105, 106 with suitable protrusions to accomplish such task. For example, shearing device 600 may be replaced with grasping components such that the device functions or may be incorporated into a pair of pliers, graspers, or spreaders. The shaft components 132, 138 of the first and second members 151, 152 may have threaded regions 141, 142 (or other mechanical coupling means) such that various endpoints, adaptable for various applications, may be attached to the shafts 132, 138.

FIGS. 8A-8B are perspective views of another embodiment of a hand-held shearing device 800 consistent with the present disclosure. FIG. 8A shows the shearing device 800 in a closed position. The handles 171, 172 of the first and second members have a different area such that the area of handle 171 is significantly greater than the area of handle 172.

Handle 172 may facilitate a thumb grip whereas handle 171 may allow a grip by any of the four fingers. In the embodiment shown in the figure, hand-held shearing device 800 is configured for a right-handed operation. However, the present disclosure is not limited thereto and may also be reconfigured for left-handed operation as well. The left-handed embodiment can be the mirror image of the right-handed embodiment.

In some embodiments, the distance 173 between the fulcrum 176 and handles 171, 172 can be great enough to prevent a user's pinky from getting caught between the blades of each member 175, 177 for a standard size of scissors or shears. The distance 173 between the fulcrum 176 and handles 171, 172 may be 2.5 inches but need not be limited thereto. Shearing device 800 may include other features such as a pinky rest, ridge, or baffle to reduce the risk of user injuries.

FIG. 8B is an illustration of a shearing device 800 in an open position 178. As shown, shearing device 800 may employ a cutting action by rotating the first and second members 175, 177 relative to each other (e.g., clockwise and counterclockwise).

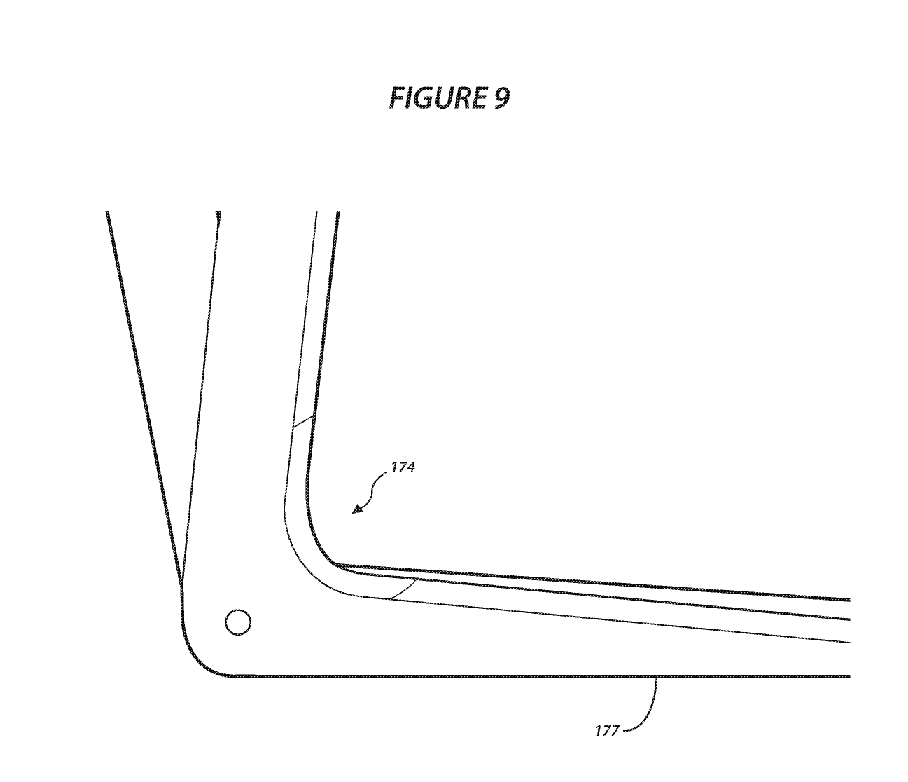

FIG. 9 is a close-up view of a rounded-chamfered material guide 174 of the shearing device's blade according to an embodiment of the present disclosure. In operation, the blade which is controlled by the fingers extends below the medium being cut and therefore has the material guide. In the embodiment shown, the rounded-chamfered material guide 174 is fashioned on a second member 177 of a hand-held shearing device. The rounded-chamfered material guide 174 may help prevent a shearable medium (e.g., paper or cardboard) from getting jammed during a cutting action. In this embodiment, the chamfer of the edge of the cutting portion of the blade is integrated with the rounded-chamfered material guide 174 to discourage the medium from riding up the blade while the embodiment is pushed through the medium during a cutting action. If the medium is rigid and rides up the blade anyway, then the rounded-chamfered material guide 174 will allow it to pass by the leading rising edge of second member 177 without binding.

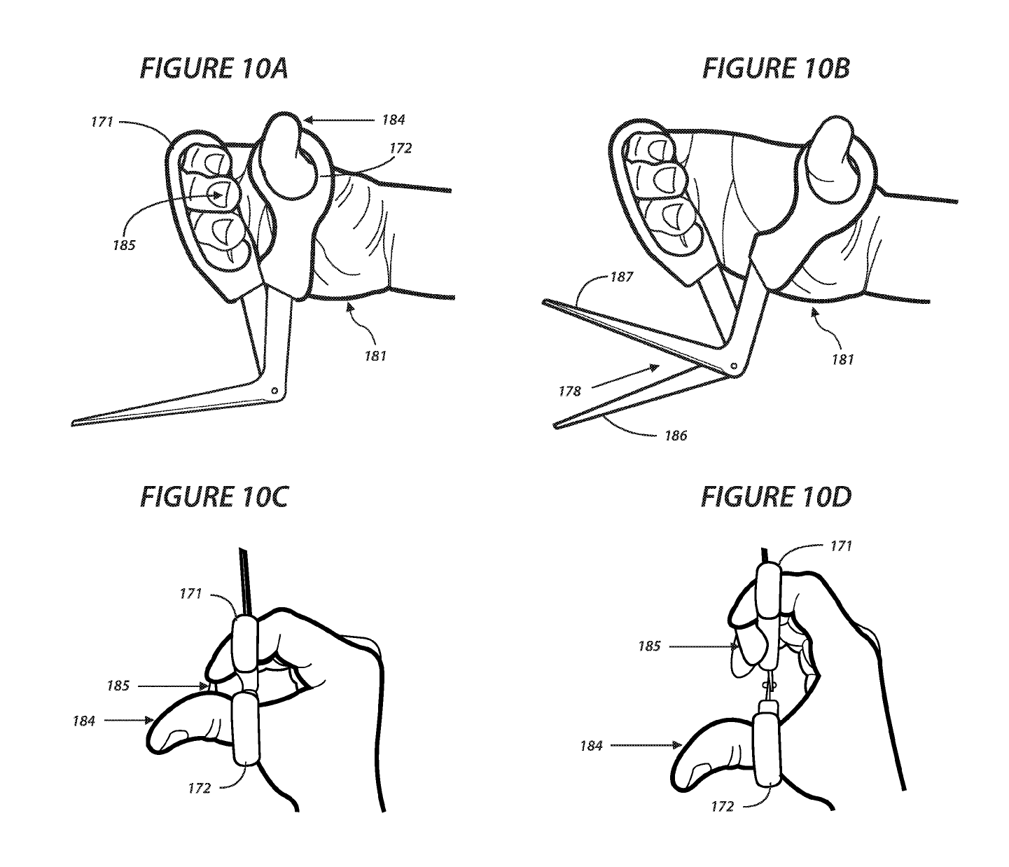

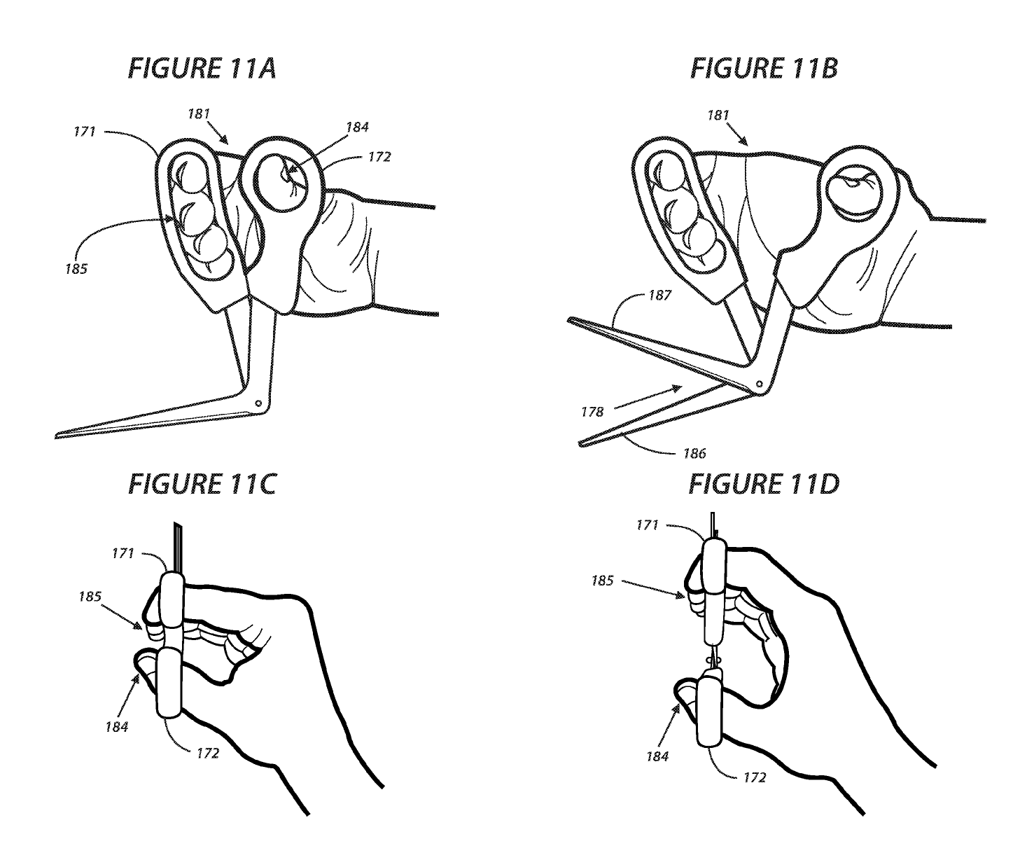

The hand-held shearing device can operate in at least two modes—a strength mode and a precision mode. FIGS. 10 and 11 provide illustrations of the hand-held shearing device being gripped in accordance with both strength and precision modes, respectfully.

FIGS. 10A-10D are exemplary illustrations of the hand-held shearing device of FIG. 8 being held during a strength operating mode. FIG. 10A illustrates a side view of the hand-held shearing device in a closed position. In strength mode, an individual grips the hand-held shearing device (with a right hand 181 for this configuration) such that the thumb 184 extends through a first handle 172 with the handle at the base of the thumb, and the fingers 185 extend through the second handle 171 to facilitate a sturdy grip. In strength mode, the hand-held shearing device can cut, for example a thick shearable medium or multiple sheets of paper at one time.

FIG. 10B illustrates a side view of the shearing device in an open position. When an individual grips the shearing device in an open position, when in strength mode, a gap 178 between blades 186, 187 allows a shearable medium to be cut there between.

FIG. 10C shows a top view of the hand-held shearing device in a closed position. In this view, the thumb 184 is shown disposed through handle 172 whereas fingers 185 are disposed through handle 171. It should be noted that in strength mode, the thumb 184 and fingers 185 extend through the openings of the handles, with the thumb extended through the handle all the way to the base of the thumb.

In FIG. 10D, a top view of the hand-held shearing device is shown in an open position in strength mode. Particularly, the manner in which the thumb 184 and fingers 185 are disposed through handles are shown when the hand-held shearing device is in this position, with the thumb extended through the handle all the way to the base of the thumb.

FIGS. 11A-11D are exemplary illustrations of the hand-held shearing device of FIG. 8 being held during a precision operating mode. In the precision operation mode, the hand-held shearing device can be used to cut a sheet of paper or other shearable medium with a high degree of accuracy.

FIG. 11A illustrates a side view of the shearing device in a closed position. In the precision operating mode, an individual grips the hand-held shearing device (with a right hand 181 for this configuration) such that the tip of the thumb 184 and the fingers 185 grip the handles 171, 172. In precision mode, the shearing device can cut a sheet of paper very precisely. The primary difference between strength mode and precision mode is that in strength mode the handle 172 is at the base of the thumb, and in precision mode the handle 172 is at the tip of the thumb, which facilitates the strength and precision respectively.

FIG. 11B illustrates a side view of the hand-held shearing device in an open position in precision mode. When an individual grips (with hand 181) the hand-held shearing device in an open position, a gap 178 between blades 186, 187 allows a shearable medium to be cut there between.

FIG. 11C shows a top view of the hand-held shearing device in a closed position in precision mode. In this view, the thumb 184 is shown disposed through handle 171 whereas fingers 185 are disposed through handle 172. It should be noted that in precision mode, the thumb 184 and fingers 185 extend through the openings of the handles, with only the tip of the thumb extended through the handle.

In FIG. 11D, a top view of the shearing device is shown in an open position in precision mode. Particularly, the manner in which the thumb 184 and fingers 185 are disposed through handles are shown when the shearing device is in this position, with only the tip of the thumb extended through the handle.

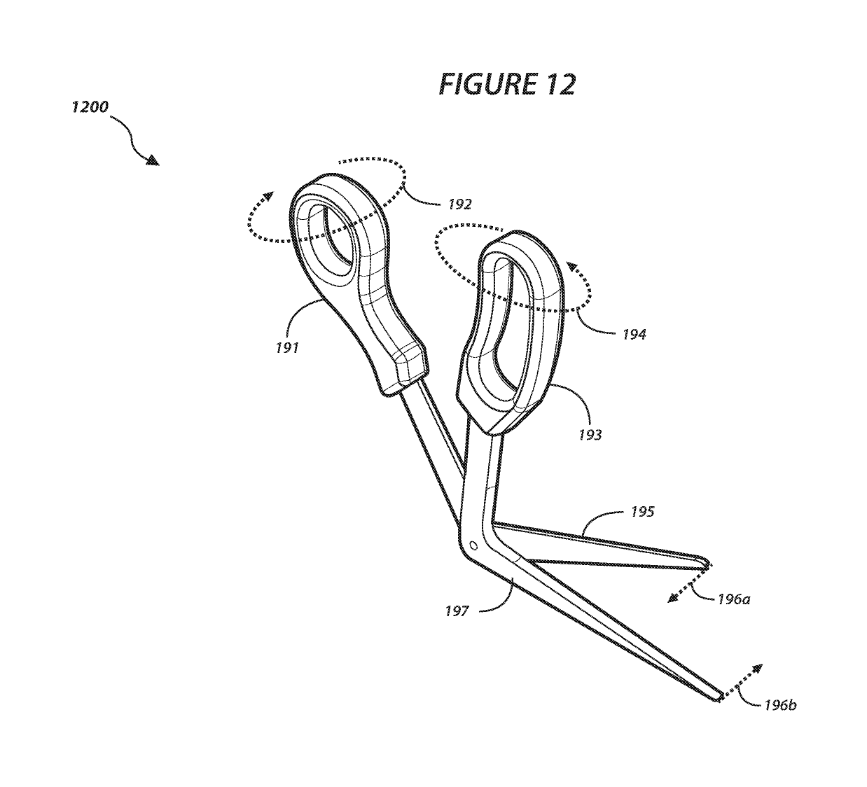

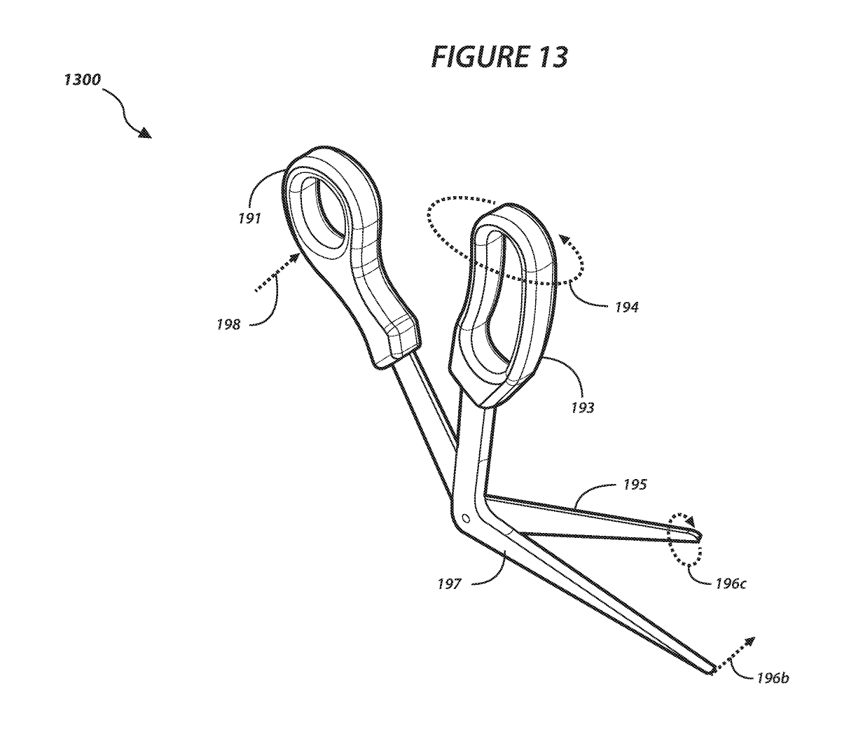

FIG. 12 is an exemplary illustration of a manner in which a hand-held shearing device 1200 produces cross-torque according to a right-handed embodiment of the present embodiment. To employ a cutting action, a user brings his hand together as making a fist (e.g., by the natural curling of the fingers) to bring the handles 191, 193 together thereby cutting a shearable medium. The ability to create cross-torque allows the user to create shear along the full length of the blades during action. As with existing pairs of scissors and shears known in the art, the fulcrum can be slightly loose and one or both of the blades can be slightly curved towards each other so that towards the tips of the shears the curve in the blades causes them to shear together during a cutting action without additional cross-torque supplied by the user. Shearing devices 1200, 1300 (see FIG. 13) allow the user to create cross-torque and therefore a shearing force closer to the fulcrum and along the entire length of the blades similar to the cross-torque created in existing pairs of scissors and shears.

While moving the fingers in a motion similar to making a fist during a cutting action, a clockwise force 192 can be applied to the first handle 191 by the thumb whereas a counterclockwise force 194 is applied to the second handle 193 by the fingers. The effect of the aforementioned forces on the handles 191, 193 create a cross-torque 196a (i.e., created by the thumb) on blade 195 and a cross-torque 196b (i.e., created by fingers) on blade 197. The cross-torque described in FIG. 12 can be created while using the embodiment in precision mode, but need not be limited only to precision mode.

FIG. 13 is another exemplary illustration of a manner in which a hand-held shearing device 1300 produces cross-torque according to a right-handed embodiment of the present embodiment. In the alternate embodiment shown, a user's thumb or the base of the thumb can apply a vector force 198 against a handle 191 according to a right-handed configuration. This is similar to the force applied by the thumb in a regular pair of scissors or shears. Throughout the cutting action, the vector force applied by the thumb or base of the thumb can be roughly perpendicular to the handle and to the path of the handle as it moves.

In operation, a user can close their hand in a manner similar to making a fist action to create a counterclockwise force 194 on the second handle 193, which can create a cross-torque force 196b. In addition, a rotational force 196c is created by thumb force 198 which rotates the whole edge of the blade 195 towards the other blade 197 enabling shearing along the length of the blades. The cross-torque described in FIG. 13 can be created while using the embodiment in strength mode but need not be limited thereto.

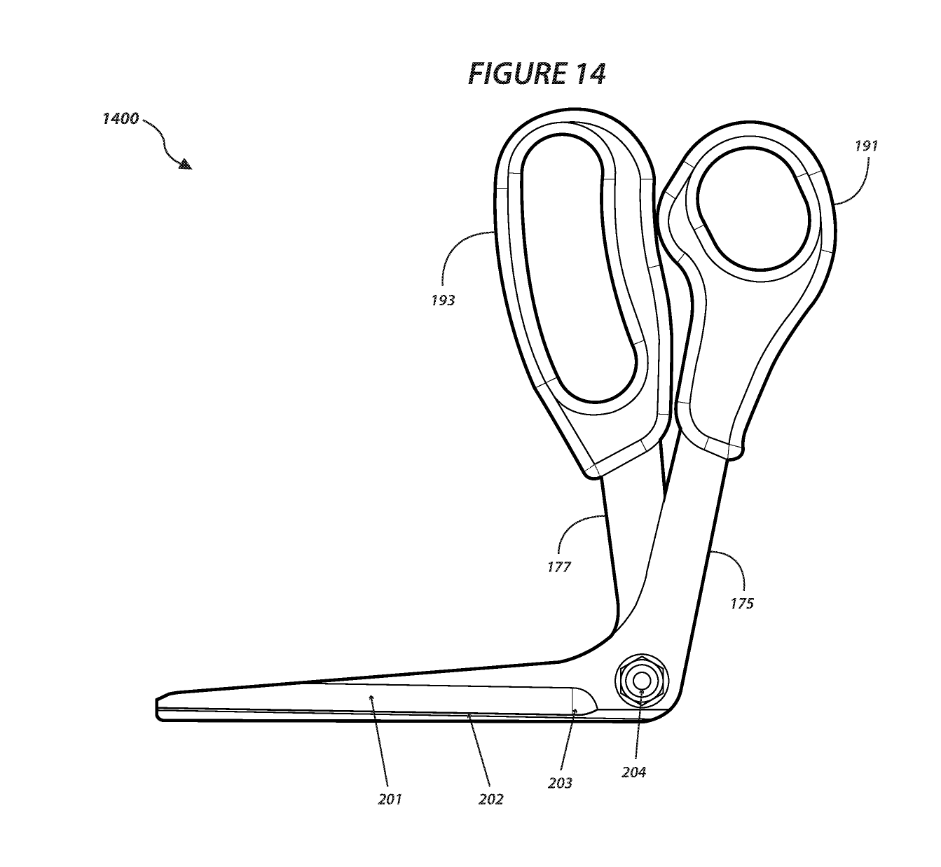

FIG. 14 is an illustration of a first side of another hand-held shearing device 1400 embodiment of the present invention. Notably, the hand-held shearing device 1400 depicted in FIG. 14 features a first member 175 with a protrusion which has a beveled region 201 above the cutting edge of the protrusion. The cutting edge 202 may extend the entire span of the protrusion as depicted in the figure. However, the beveled region 201 may extend to but not beyond the pivot point 204 (see region 203), depending on whether the beveled region 201 would intersect with the pivot point 204.

In some embodiments, the beveled region 201 of the protrusion of the first member 175 may be approximately 19°. Further, in some embodiments, the cutting edge 202 of the first member 175 may be approximately 55°. These measurements are intended to be exemplary as it is known in the art that scissor edges and bevels can have a wide range of angles depending upon the application.

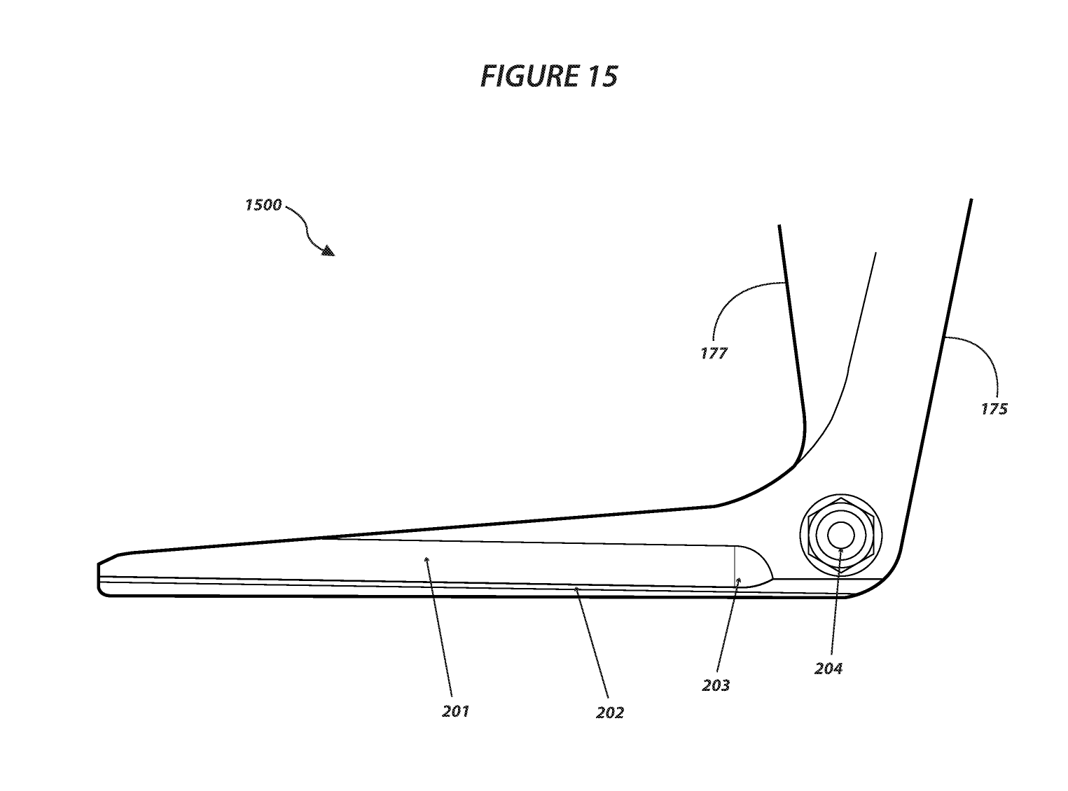

FIG. 15 is an illustration of a close-up view of one of the protrusions of the hand-held shearing device 1400 of FIG. 14. As shown, the difference in angles of the beveled region 201 and cutting edge 202 is clearly shown. It is advantageous that the hand-held shearing device 1500 be configured in the aforementioned manner as the shearing device 1400 allows a shearable medium to more easily slide there through before, after, and during a cutting action. Moreover, the beveled region 201 allows better visibility while cutting along a precise path during a cutting action. For one or more embodiments of the present invention configured for right-handed operation, as shown in FIGS. 12 and 13, and erected upright with the protrusions below the handles, when held in the right hand, the beveled region 201 provides needed visibility to cut along a precise path. This may be symmetrically consistent for some left-handed embodiments of the present invention when the hand-held shearing device 1500 is held in the user's left hand.

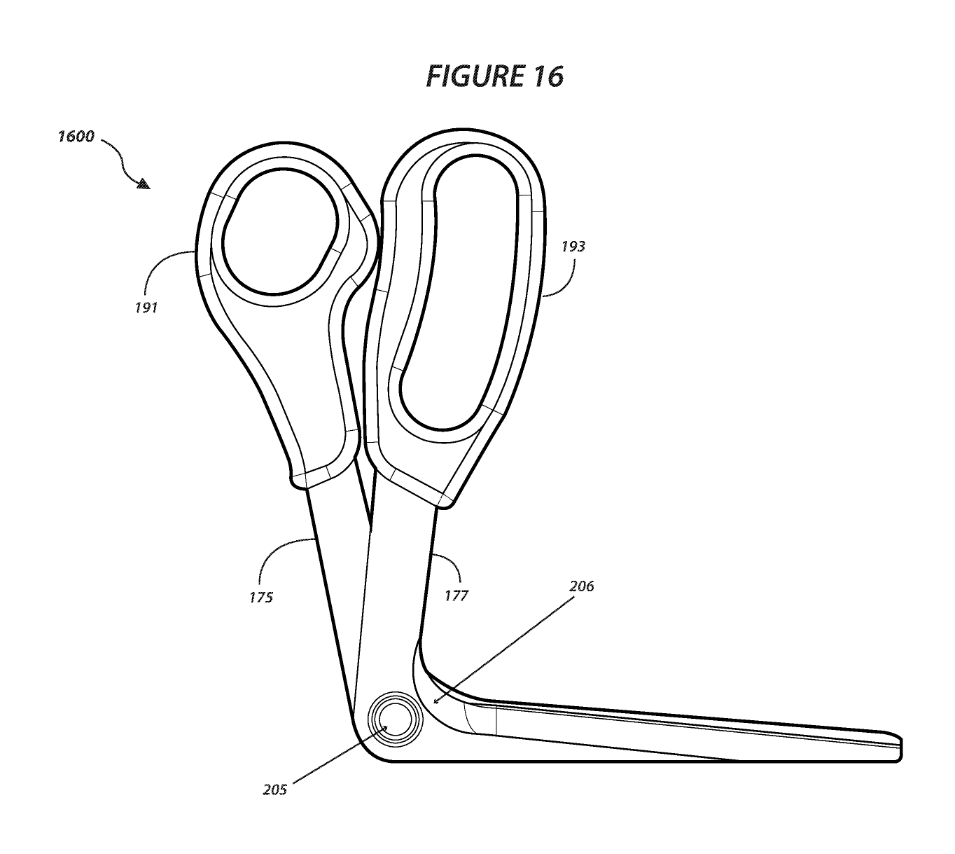

FIG. 16 is an illustration of a second side of another hand-held shearing device 1600 embodiment of the present invention. The second side of hand-held shearing device 1600 exposes a second side of pivot point 205. In addition, FIG. 16 the cutting edge of second member 177 may include a chamfered portion 206 to act as the material guide and reduce the impediment during a cutting action.

This disclosure pertains to a hand-held shearing device and in particular to an inverted hand-held shearing device for various cutting applications. It will be understood by those having ordinary skill in the art that the present disclosure may be embodied in other specific forms without departing from the spirit and scope of the disclosure disclosed. In the examples and embodiments described herein are in all respects illustrative and not restrictive. Those skilled in the art of the present disclosure will recognize that other embodiments using the concepts described herein are also possible.

1. A hand-held shearing device, comprising:
a first member and a second member coupled together by a pivot point such that each member can rotate independently;
wherein the first member comprises a first handle and the second member comprises a
second handle on a first region of each member;
wherein the area of the second handle is greater than the area of the first handle; and
a protrusion on a second region of each member;
wherein each protrusion is disposed at least sixty-five degrees from the corresponding handle of each member;
wherein during a cutting action, a cross-torque force is applied upon the protrusion of the second member by the first member or a cross-torque force is applied upon the protrusion of the first member by the second member.

2. The hand-held shearing device of claim 1, wherein the protrusions are at least one of a pair of blades, prongs, or needles.

3. The hand-held shearing device of claim 1, wherein the hand-held shearing device is at least one of a pair of cutters, clippers, graspers, pliers, spreaders, or scissors.

4. The hand-held shearing device of claim 1, wherein the first handle has a shape that accommodates a gripping of a thumb or base of the thumb.

5. The hand-held shearing device of claim 1, wherein the second handle has a shape that accommodates the gripping of one to four fingers.

6. The hand-held shearing device of claim 1, wherein an interior angle portion is disposed between the first region and the second region of the second member which includes a rounded-chamfered material guide.

7. The hand-held shearing device of claim 1, wherein for right-handed embodiments, during a cutting action, a clockwise force or vector force is applied to the first handle and a counterclockwise force is applied to the second handle.

8. A pair of scissors, comprising:
a first member and a second member coupled together by a fulcrum such that each member can rotate independently in a clockwise direction or a counterclockwise direction;
wherein the first member comprises a first handle and the second member comprises a second handle;
wherein the area of the second handle is greater than the area of the first handle; and
a blade at a second end of each member;
wherein in response to erecting the pair of scissors, each respective blade is disposed below or above each corresponding handle to facilitate an overhand grip of the pair of scissors;
wherein during a cutting action, a cross-torque force is applied upon the blade of the second member by the first member or a cross-torque force is applied upon the blade of the first member by the second member.

9. The pair of scissors of claim 8, wherein the first handle and the second handle has an eye-ring shape.

10. The pair of scissors of claim 8, wherein the distance between the fulcrum and each handle is at least two inches.

11. The pair of scissors of claim 8, wherein the first handle includes a thumb groove and the second handle includes finger grooves.

12. The pair of scissors of claim 8, wherein an interior angle portion is disposed between the first region and the second region of the second member and includes a rounded-chamfered material guide and wherein the rounded-chamfered portion is fashioned to prevent a shearable medium from getting jammed during a cutting action.

13. The pair of scissors of claim 8, wherein the first member includes a palm heel groove.

14. The pair of scissors of claim 8, wherein a first blade is at a bottom portion at the second end of the first member and a second blade is at a top portion at the second end of the second member.

15. The pair of scissors of claim 8, wherein the pair of scissors is configured for a right-hand operation or a left-hand operation.

16. The pair of scissors of claim 15, wherein for the right-handed operation, during a cutting action, a clockwise force or a vector force is applied to the first handle and a counterclockwise force is applied to the second handle.

17. A hand-held shearing device, comprising:
a first member and a second member coupled together by a pivot point such that each member can rotate independently;
wherein the first member comprises a first handle and the second member comprises a second handle on a first region of each member;
wherein the area of the second handle is greater than the area of the first handle; and
a protrusion on a second region of each member;
wherein the handles and the cutting edges of the protrusions form an angle that is in a range of 45 and 90 degrees during a cutting action; wherein the inner surface of the second handle which is in contact with the at least two fingers of the hand during the cutting action is disposed in the formed angle whereas the inner surface of the first handle which is in contact with the thumb of the hand during the cutting action is disposed outside of the formed angle;
wherein the protrusion of the first member has a beveled portion above a cutting edge of the first member;
wherein during a cutting action, a cross-torque force is applied upon the protrusion of the second member by the first member or a cross-torque force is applied upon the protrusion of the first member by the second member.
wherein the pivot point is located to facilitate an opening and a closing of the hand-held shearing device during a cutting action.

18. The hand-held shearing device of claim 17, wherein the beveled portion has approximately a 19° slope.

19. The hand-held shearing device of claim 17, wherein the cutting edge has approximately a 55° slope.

20. The hand-held shearing device of claim 17, wherein the cutting edge spans the entire length of the second region of the first member.

21. The hand-held shearing device of claim 17, wherein the beveled portion extends from a first end of the first protrusion to no further than the pivot point.

22. The hand-held shearing device of claim 17, wherein for the right-handed operation, during a cutting action, a clockwise force or a vector force is applied to the first handle and a counterclockwise force is applied to the second handle.

23. A pair of scissors, comprising:
a first member and a second member coupled together by a fulcrum such that each member can rotate independently in a clockwise direction or a counterclockwise direction;
wherein the first member comprises a first handle and the second member comprises a second handle;
wherein the area of the second handle is greater than the area of the first handle; and
a blade at a second end of each member;
wherein at least one of the blades is curved towards the other;
wherein in response to erecting the pair of scissors, each respective blade is disposed below or above each corresponding handle to facilitate an overhand grip of the pair of scissors;
wherein during a cutting action, a cross-torque force is applied upon the blade of the second member by the first member or a cross-torque force is applied upon the blade of the first member by the second member.

24. The pair of scissors of claim 23, wherein the blade of the first member has a beveled portion above a cutting edge of the first member.

25. The pair of scissors of claim 23, wherein the beveled portion has approximately a 19° slope.

26. The pair of scissors of claim 23, wherein the protrusion of the second member has a beveled portion below a cutting edge of the second member.
